(19) United States
(12) Patent Application Publication
(10) Pub. No.: US 2012/0020541 A1
(43) Pub. Date: Jan. 26, 2012

(54) RADIOGRAPHIC APPARATUS AND CONTROL METHOD FOR THE SAME

(75) Inventor: Shinsuke Hayashida, Yokohama-shi (JP)

(73) Assignee: Canon Kabushiki Kaisha, Tokyo (JP)

(21) Appl. No.: 13/262,417

(22) PCT Filed: Apr. 13, 2010
(86) PCT No.: PCT/JP2010/056893

§ 371 Date: Sep. 30, 2011

(30) Foreign Application Priority Data
May 12, 2009 (JP) 2009-115918

(51) Int. Cl. G06K 9/40; G06K 9/00

(52) U.S. Cl. 382/132; 382/275

(57) ABSTRACT

A radiographic apparatus which includes an X-ray irradiation unit which irradiates X-rays and an X-ray detection unit which detects an X-ray image of an object irradiated by the X-ray irradiation unit includes a first defect detection unit which detects, as a position-dependent defect, a pixel, of X-ray images, whose pixel value is always abnormal, and acquires position information of the defect in the X-ray image, a second defect detection unit which detects, as a defect, a pixel, of the X-ray images, which temporarily becomes abnormal dependent on the lapse of time, and a determination unit which determines a correction method for correcting the pixel value of the pixel in which the abnormality is detected by the second defect detection unit, based on the information indicating the imaging condition.

### TECHNICAL FIELD

The present invention relates to a radiographic apparatus and a control method for the same.

### BACKGROUND ART

With recent demands for the digitization of images, a digital imaging apparatus having a function of outputting digital images has begun to be used as a radiographic apparatus, which captures a radiation image transmitted through an object. A computed radiographic apparatus is used to perform general imaging by using an imaging plate which stores a radiation image as a latent image, in place of a screen-film system, and excites the latent image by laser-scanning the imaging plate. This apparatus reads the fluorescence produced by this operation via a photoelectron multiplier. An I.I.-DR imaging apparatus is also used to capture moving images, which uses a solid-state imaging device such as a CCD in place of an image pickup tube. Both the apparatuses have a function to output digital images. This is beginning to contribute to the digitization of medical images. There is also available a digital imaging apparatus which directly digitizes a radiation image without via an optical system and the like by using a so-called FPD (Flat Panel Detector), which is a radiation flat panel detector having a phosphor and a large-area amorphous silicon sensor arranged in tight contact with each other.

Conventionally, as disclosed in Japanese Patent Laid-Open No. 2005-006196 and Japanese Patent No. 4124915, a radiation flat panel detector (FPD) registers defect positions (defect coordinate map) in advance, and always corrects predetermined pixels based on the defect positions. According to Japanese Patent Laid-Open No. 2005-006196, the flat panel detector extracts first and second defective pixels. According to Japanese Patent No. 4124915, the flat panel detector segments an image into a plurality of areas, obtains a standard deviation, and extracts a defective pixel within each area.

There has not been available any means for, for example, changing abnormal pixel correction methods depending on whether an abnormal pixel is a permanently abnormal pixel or a temporarily abnormal pixel. This makes it impossible to correct abnormal pixels by proper methods.

### SUMMARY OF INVENTION

The present invention provides a radiographic apparatus, which can choose between spatial correction and temporal correction in accordance with whether an abnormal pixel is a permanently abnormal pixel or a temporarily abnormal pixel.

According to one aspect of the present invention, there is provided a radiographic apparatus including X-ray irradiation means for irradiating X-rays and X-ray detection means for detecting an X-ray image of an object irradiated by the X-ray irradiation means, the apparatus comprising:

first defect detection means for detecting, as a position-dependent defect, a pixel, of a plurality of X-ray images detected by the X-ray detection means, whose pixel value is always abnormal, and acquiring position information of the defect in the X-ray image;

first defect correction means for correcting the pixel value of the pixel in which an abnormality is detected, based on the position information and a pixel value of a neighboring pixel of the pixel in which the abnormality of the pixel value is detected;

acquisition means for acquiring information indicating an imaging condition for the object when the X-ray detection means detects the X-ray image;

decision means for deciding, based on the information indicating the imaging condition acquired by the acquisition means, whether to further correct the X-ray image corrected by the first defect correction means;

second defect detection means for, when the decision means decides to further correct the X-ray image, detecting, as a defect, a pixel, of the plurality of X-ray images detected by the X-ray detection means, which temporarily becomes abnormal dependent on a lapse of time;

determination means for determining a correction method for correcting the pixel value of the pixel in which the abnormality is detected by the second defect detection means, based on the information indicating the imaging condition; and

second defect correction means for correcting the pixel value of the pixel detected by the second defect detection means in accordance with the correction method determined by the determination means.

The present invention can provide a radiographic apparatus, which can choose between spatial parameter correction and temporal parameter correction for a temporarily defective pixel.

In addition, it is possible to provide a radiographic apparatus, which can change to a suitable correction method for an abnormal pixel which does not always appear, like an X-ray shot noise pixel or an abnormal dot pixel, in accordance with imaging conditions.

Further features of the present invention will become apparent from the following description of exemplary embodiments (with reference to the attached drawings).

### BRIEF DESCRIPTION OF DRAWINGS

FIG. 1 is a schematic block diagram showing the overall arrangement of a radiographic apparatus according to an embodiment;

FIGS. 2A and 2B are views for explaining space/time-dependent defect correction and defect correction based on weighting;

FIG. 3 is a flowchart for explaining a processing procedure in the radiographic apparatus;

FIG. 4 is a view for exemplarily explaining a statistic distribution when X-ray photons mix with visible light photons and interact with each other;

FIGS. 5A and 5B are views for conceptually explaining abnormal pixel correction methods;

FIG. 6 is a view for exemplarily explaining the influences of X-ray shot noise on image quality in accordance with X-ray doses;

FIG. 7A is a flowchart for explaining a processing procedure in the radiographic apparatus according to the embodiment;

FIG. 7B is a view in which (7a) represents an example of an operation window of the radiographic apparatus, and (7b) represents the relationship between enhancement frequencies and enhancement degrees in a bone region and a soft tissue region as body parts;

FIG. 7C is a view exemplarily showing the relationship between an enhancement frequency and an enhancement degree for each body part;

FIG. 8 is a graph exemplarily showing the relationship between spatial frequencies and MTFs (Modulation Transfer Functions);

FIG. 9 is a block diagram for explaining the arrangement of a weight calculation unit for information acquired at the time of imaging (information acquired at imaging);

FIG. 10 is a view showing calculation results on weighting information;

FIG. 11 is a graph showing the relationship between an additional value (input) of weighting information and an output value of weighting information at the time of execution of the second defect correction;

FIG. 12 is a view showing the relationship between the maximum frame rate and the total number of pixels (pixel binning);

FIG. 13 is a view exemplarily showing images respectively corresponding to large and small movements of objects in the images;

FIG. 14 is a flowchart for explaining a processing procedure in the radiographic apparatus according to the embodiment;

FIG. 15 is a view for explaining conventional defect correction dependent on spatial positions;

FIG. 16 is a block diagram for explaining the arrangement of a radiographic apparatus;

FIG. 17 is a flowchart for explaining a processing procedure in the radiographic apparatus; and

FIG. 18 is a flowchart for explaining a processing procedure in the radiographic apparatus.

### DESCRIPTION OF EMBODIMENTS

The preferred embodiments of the present invention will be exemplarily described in detail below with reference to the accompanying drawings.

### First Embodiment

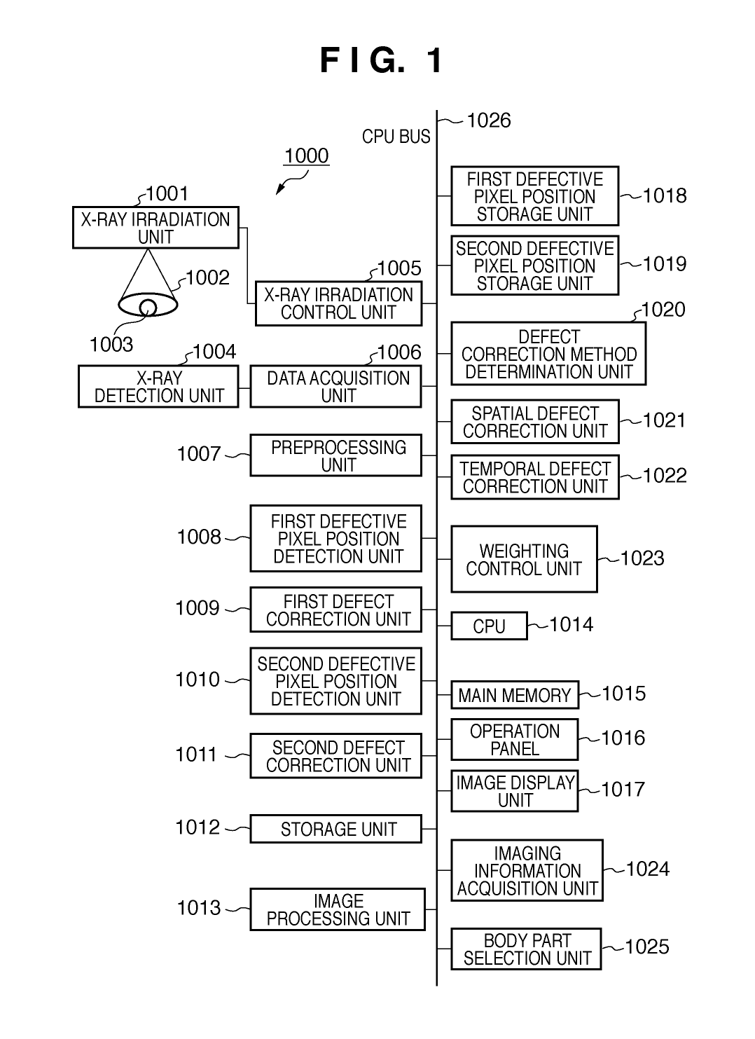

The arrangement of a radiographic apparatus will be described with reference FIG. 1. An X-ray irradiation unit 1001 which irradiates an X-ray beam X and an X-ray detection unit 1004 which detects an X-ray beam 1002 face each other through an object 1003. An X-ray irradiation control unit 1005 connected to the X-ray irradiation unit 1001 controls X-ray irradiation from the X-ray irradiation unit 1001. The X-ray detection unit 1004 is connected to a data acquisition unit 1006. The data acquisition unit 1006 performs, for example, A/D conversion, amplification, X-ray image data rearrangement, and the like for X-ray image data (to be simply referred to as “images” hereinafter) output from the X-ray detection unit 1004. The obtained images are stored in a main memory 1015 via a preprocessing unit 1007. A first defective pixel position detection unit 1008 detects (first defect detection) the position information (first defective pixel position) of each pixel in a permanently defective state (permanently defective pixel), which is detected by the X-ray detection unit 1004, in the inspection step at the time of shipment. The position information of the permanently defective pixels (first defective pixel positions (defective pixel position map)) is stored in a first defective pixel position storage unit 1018. A first defect correction unit 1009 performs defect correction (first defect correction) by using the defective pixel position map in the first defective pixel position storage unit 1018 and spatially neighboring pixels arranged near a defective pixel of the two-dimensionally arrayed pixels constituting X-ray image data. An imaging information acquisition unit 1024 acquires and stores information indicating imaging conditions such as dose information and a body part at the time of imaging the object 1003 via, for example, the X-ray irradiation control unit 1005 and the X-ray detection unit 1004.

The X-ray irradiation control unit 1005 and the data acquisition unit 1006 are connected to a CPU bus 1026. The main memory 1015, an image processing unit 1013, a CPU 1014, an operation panel 1016, and an image display unit 1017 are also connected to the CPU bus 1026. The main memory 1015 stores various kinds of data necessary for processing in the CPU 1014, and also functions as a working memory for the CPU 1014. The CPU 1014 functions as a control means for a radiographic apparatus 1000, and performs, for example, operation control of the overall apparatus in accordance with operation from the operation panel 1016 by using the main memory 1015. The preprocessing unit 1007 performs the gain correction processing of correcting variations in sensitivity of the X-ray detection unit 1004 for each pixel, and the dark current correction processing of correcting variations in dark current in the X-ray detection unit 1004 for each pixel. A gain correction image and a dark current correction image are stored in the main memory 1015 before radiography. The preprocessing unit 1007 can read out these images at the time of correction as needed. When the user inputs an imaging instruction via the operation panel 1016, the contents of the imaging instruction are stored in a storage unit 1012 and displayed on the operation panel 1016. Body parts are displayed via the operation panel 1016. A body part selection unit 1025 then selects a specific body part based on the instruction input by the user via the operation panel 1016. The imaging information acquisition unit 1024 acquires and stores information corresponding to the body part, for example, a frequency to be enhanced and an enhancement degree, stored in the storage unit 1012 in advance, based on the information of the body part selected by the body part selection unit 1025. When the user issues an instruction to generate X-rays by using the operation panel 1016 of the X-ray generator thereafter, the CPU 1014 controls the X-ray irradiation unit 1001 and the X-ray detection unit 1004 via the X-ray irradiation control unit 1005 to execute radiography.

In radiography, first of all, the X-ray irradiation unit 1001 irradiates the object 1003 with the X-ray beam 1002. The irradiated X-ray beam X is transmitted through the object 1003 while being attenuated, and then reaches the X-ray detection unit 1004 to be detected. The X-ray detection unit 1004 outputs the detected X-ray image signal. In this embodiment, the object 1003 can be a human body. In this case, the X-ray image output from the X-ray detection unit 1004 becomes an image (human body image) transmitted through the human body. The data acquisition unit 1006 performs A/D conversion and the like for the X-ray image (signal) output from the X-ray detection unit 1004 to convert the data into a predetermined digital signal, and supplies it as X-ray image data to the preprocessing unit 1007. The preprocessing unit 1007 performs preprocessing such as dark current correction processing and gain correction processing for the X-ray image data. The preprocessed X-ray image data is transferred as original image data to the main memory 1015 via the CPU bus 1026 under the control of the CPU 1014. The first defect correction unit 1009 performs defect correction by using the defective pixel position map in the first defective pixel position storage unit 1018 and the spatially neighboring pixels arranged near the defective pixel of the two-dimensionally arrayed pixels constituting the X-ray image data. The defect-corrected image data is transferred to the main memory 1015 via the CPU bus 1026 under the control of the CPU 1014.

A second defective pixel position detection unit 1010 detects a defect in each defect-corrected image data (second defect detection). The second defective pixel position detection unit 1010 extracts, for each image, a temporarily defective pixel such as an X-ray shot noise pixel produced when X-ray photons interact with each other or an abnormal dot pixel produced when noise accidentally mixes in the semiconductor X-ray detector. A second defective pixel position storage unit 1019 stores the extracted defect for each image. A second defect correction unit 1011 performs defect correction (second defect correction) of the detected temporarily defective pixels, and transfers them to the main memory 1015 via the CPU bus 1026 under the control of the CPU 1014.

By using the information stored in the imaging information acquisition unit 1024 and indicates dose information, a body part, and the like, a defect correction method decision unit 1020 decides which one of a plurality of correction methods is to be used to perform defect correction (second defect correction) of a defective pixel.

The second defect correction unit 1011 performs defect correction (second defect correction) of a defective pixel based on the decision result obtained by the defect correction method decision unit 1020. The second defect correction unit 1011 corrects the defective pixel (second defect correction) by using a spatial defect correction unit 1021 and a temporal defect correction unit 1022. The second defect correction unit 1011 further corrects the defective pixel (third defect correction) with respect to the X-ray image data having undergone the second defect correction by using the method controlled by a weighting control unit 1023 which performs weighting for spatial/temporal defect correction. The X-ray image data having undergone the second defect correction is transferred to the main memory 1015 and the image processing unit 1013 via the CPU bus 1026 under the control of the CPU 1014. The image processing unit 1013 performs noise reduction processing, frequency processing, and tone processing, and outputs the resultant X-ray image data to the image display unit 1017.

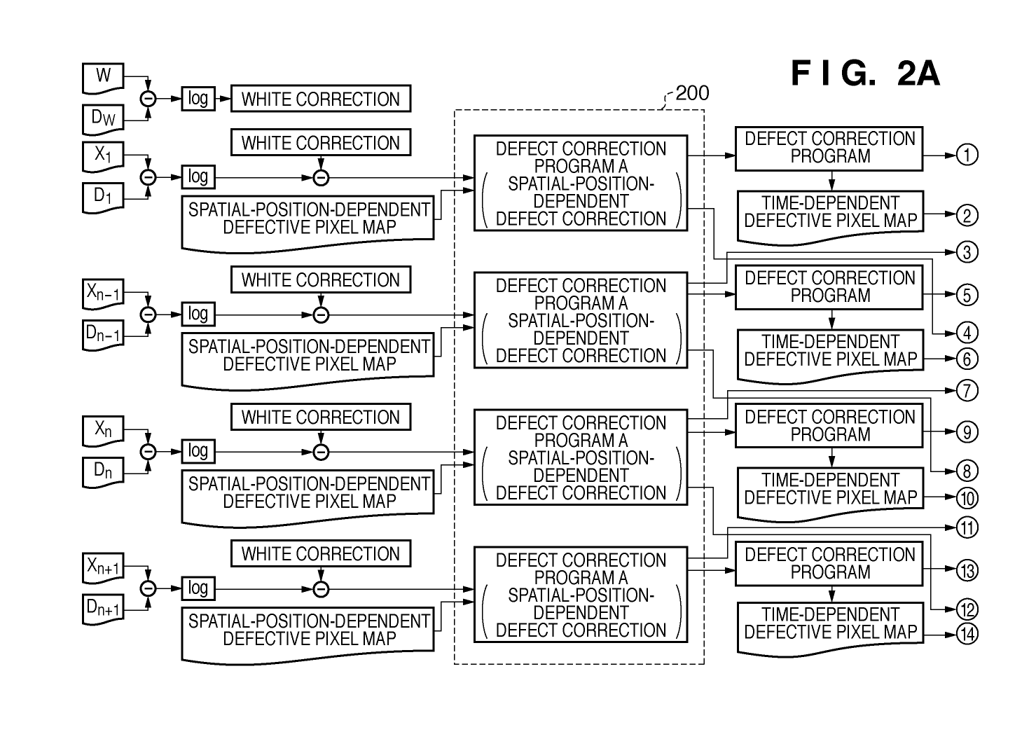

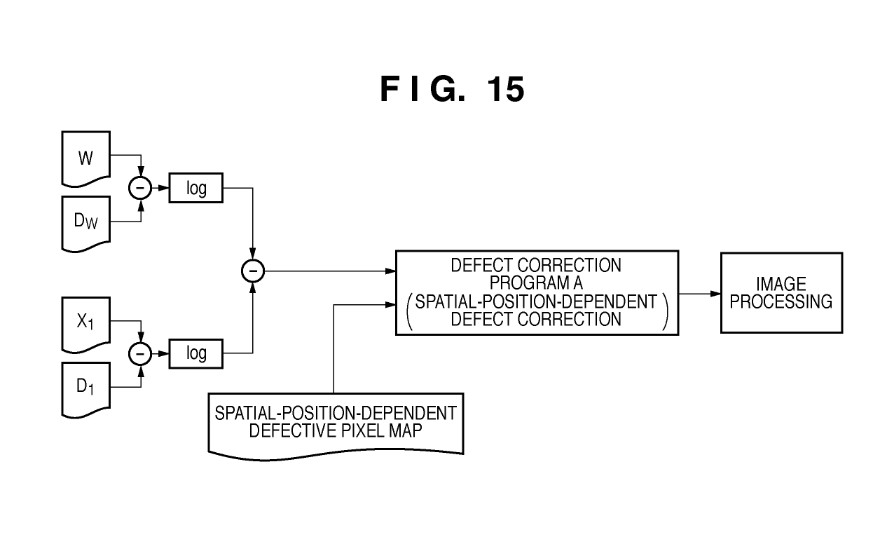

Space/time-dependent defect correction and defect correction based on weighting will be described with reference to FIGS. 2A and 2B. Conventional defect correction dependent on spatial positions will be described with reference to FIG. 15. In both the correction techniques, captured Xn (n=1, . . . , n+1: n is a natural number) images are corrected by Dn (n=1, . . . , n+1: n is a natural number) images for black correction. Likewise, both the correction techniques are the same up to the processing of correcting W images acquired in advance by using Dw images for black correction and performing white correction. Referring to FIG. 15, a defect correction program A (spatial-position-dependent defect correction) is executed by using a spatial-position-dependent defective pixel map Defspace. After the execution of spatial-position-dependent defect correction, the process shifts to image processing for displaying the resultant image on the image display unit. Referring to FIGS. 2A and 2B, a block 201 performs the first defect correction by using the defect correction program A. A block 202 performs the second defect correction by using either the spatial-position-dependent defect correction program A or a defect correction program B for time-dependent defect correction. A block 203 performs the third defect correction by using a defect correction program C based on weighting of the defect correction programs A and B. As inputs to the defect correction program B for time-dependent defect correction, the time-dependent defect pixel map Deftime and temporarily adjacent frame images are input.

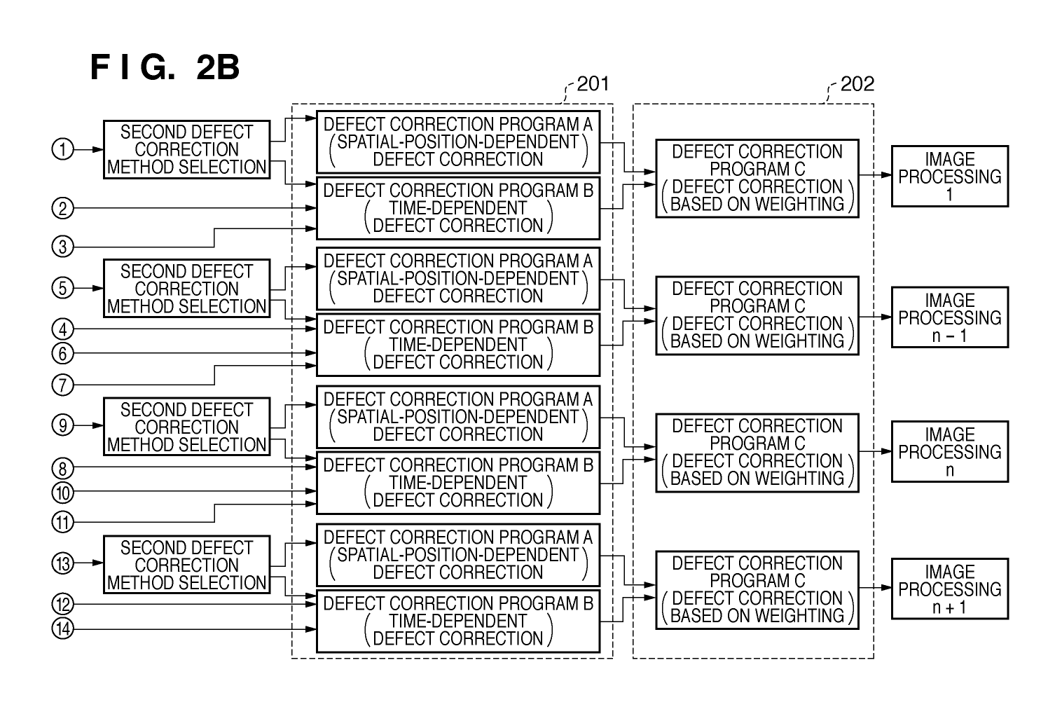

A processing procedure in the radiographic apparatus according to this embodiment will be described with reference to FIG. 3. In step S300, this apparatus performs the first defect detection. In this step, for example, the first defective pixel position detection unit 1008 detects defective pixels (permanently defective pixels) in the inspection step at the time of shipment. The position information of permanently defective pixels (first defective pixel positions (defective pixel position map)) is stored in the first defective pixel position storage unit 1018.

In step S301, the radiographic apparatus 1000 starts radiography after the completion of preparation for the apparatus. The X-ray irradiation unit 1001 generates a predetermined dose of X-rays corresponding to a body part, and irradiates the object 1003 with the X-rays. The X-ray detection unit 1004 detects X-rays transmitted through the object 1003. After the lapse of a predetermined storage time, the data acquisition unit 1006 reads out an image of detected X-rays (X-ray image). The imaging information acquisition unit 1024 stores the information acquired at the time of radiography. The imaging information acquisition unit 1024 stores the body part information input via the operation panel 1016, a spatial frequency enhancement parameter corresponding to each body part, the dose of X-rays which have reached the X-ray image detection panel included in the X-ray detection unit 1004, and the like. The data acquisition unit 1006 performs, for example, A/D conversion, amplification, and X-ray image data rearrangement for the obtained X-ray image data. These processing results are sent to the main memory 1015.

In step S302, this apparatus performs the first defect correction. The apparatus corrects spatial-position-dependent defective pixel by using the position information of permanently defective pixels (first defective pixel positions (defective pixel position map)) stored in the first defective pixel position storage unit 1018.

In step S303, the defect correction method decision unit 1020 decides whether to execute a correction method for the correction of a defective pixel (second defect correction). By using the information acquired at the time of radiography and stored in the imaging information acquisition unit 1024, the defect correction method decision unit 1020 decides whether to execute the second defect correction. The information acquired at the time of imaging (information acquired at imaging) includes, for example, an X-ray dose, body part information, frequency enhancement information, a moving amount in an image, an imaging frame rate, a pixel pitch, execution/non-execution of pixel binning, and an X-ray random noise amount. It is possible to decide, by using at least one of these pieces of information, whether to execute the second defect correction. If, for example, the X-ray dose stored in the imaging information acquisition unit 1024 is larger than a predetermined dose, the X-ray image data is input to the image processing unit 1013 without execution of the second defect detection for the execution of the second defect correction in order to correct X-ray shot noise. If the X-ray dose stored in the imaging information acquisition unit 1024 is smaller than the predetermined dose, the defect correction method decision unit 1020 decides to execute the second defect detection for the execution of the second defect correction. The process then advances to step S304.

In step S304, the second defective pixel position detection unit 1010 performs defect detection for the image having undergone the first defect correction in step S302 described above. In the second defect detection, this apparatus performs defect correction for the defective pixel or output abnormal pixel which has not been corrected by the first defect correction. In the first defect detection, the apparatus has mainly detected output abnormal pixels dependent on spatial positions as defective pixels. A cause of a defective pixel or the like can be mixing of a foreign component in a pixel when it is manufactured in a semiconductor process. The first defective pixel position detection unit 1008 also detects an abnormal output pixel originating from each signal line through which an output signal value passes or an amplifier IC, instead of each pixel as a cause, as a spatial-position-dependent defective pixel.

The pixels detected in this step mainly include time-dependent output abnormal pixels. For example, X-ray shot noise and abnormal dots are assumed as such abnormal pixels. As described later, X-ray shot noise is not a defective pixel originating from a pixel, signal line, amplifier IC, or the like. X-ray shot noise occurs when an X-ray photon transmitted through a phosphor is accidentally converted into an electrical signal due to a photoelectric effect inside a photoelectric conversion element. That is, such noise always occurs in every pixel at a predetermined probability. In addition, an abnormal dot can sometimes become a defective pixel if there is a contact failure or an unstable portion in a corresponding pixel, signal line, amplifier IC, or the like. If such pixels which are not always defective pixels are detected as permanently defective pixels in the first defect detection, there is a possibility that they will be excessively registered as defective pixels. In the present invention, in order to perform defect correction for proper pixels, the first defect detection is performed to detect abnormal pixels which always appear, whereas the second defect detection is performed to detect abnormal pixels which appear at some probability (temporarily) for each image. The purpose of this step is to detect abnormal pixels which cannot be captured as defective pixels which appear steadily.

In step S305, the defect correction method decision unit 1020 selects a correction method (second defect correction) for the correction of the defective pixel detected in step S304. In the present invention, the defect correction method decision unit 1020 can select (i) defect correction using spatially neighboring pixels, (ii) defect correction using temporally neighboring pixels, (iii) weighting defect correction using both spatially neighboring pixels and temporally neighboring pixels upon weighting, and (iv) no defect correction. Note that the pixel detected in the first defect detection is a pixel in a permanently defective state (permanently defective pixel), and hence is generally subjected to (i) defect correction using spatially neighboring pixels described above. The defect correction method decision unit 1020 decides a defect correction method using the information acquired at the time of imaging. When the number of second defective pixels detected is small, the step of detecting second defective pixels and performing the second defect correction takes much calculation time when displaying a moving image in real time. This may lead to a delay time before display. It is therefore preferable to select (iv) no defect correction described above. If, however, the above image is to be repeatedly seen afterward or used for diagnosis or the like instead of being displayed in real time, any accidental defective pixel may spoil the displayed image or exhibit an abnormal value. In this case, therefore, defect correction is performed by using one of the correction methods (i) to (iii).

(i) Defect correction using spatially neighboring pixels needs to be performed when, for example, still images are captured or the moving image frame rate is low. In this case, since there exists some time interval between adjacent frames, the object or the like may have greatly moved. In such a case, defect correction using adjacent frames results in defect correction using considerably different pixel values. The methods (ii) and (iii) are defect correction methods using temporally neighboring pixels. At the time of imaging at a high moving image frame rate, the pixel values of temporally neighboring pixels sometimes are higher in accuracy than those of spatially neighboring pixels. For example, this is the case when the object hardly moves. In such a case, (ii) defect correction using temporally neighboring pixels is used. At the time of imaging at a high frame rate, settings are often made on the radiographic apparatus side so as to read out pixels upon binning. This is because, it takes much time to read out many pixels, and hence it is difficult to read out an image at a high frame rate. In addition, the larger the image size, the more difficult it is to perform image processing such as preprocessing. Performing pixel binning will increase the distances to spatially neighboring pixels, and hence will increase the necessity to perform defect correction using temporally neighboring pixels. When, for example, a high frame rate is to be set, and this apparatus performs, for example, 2×2 pixel binning or 4×4 pixel binning instead of reading out all the pixels, a pixel size with a pitch of 160 μm is virtually regarded as a pixel size with a pitch of 320 μm or 640 μm. At this time, performing defect correction using spatially neighboring pixels will lead to the necessity to perform defect correction using pixels at distant positions and will reduce the accuracy of defect correction. That is, when imaging is performed at a high frame rate, spatially neighboring pixels are located at more spatially distant positions while temporally neighboring pixels are located temporally closer to each other. Owing to such synergistic effect, the apparatus selects the method of performing defect correction using temporally neighboring pixels.

When this apparatus does not perform the second defect correction, the process advances to step S309 to perform image processing for display. When the apparatus does not perform the second defect correction, there is a demerit that pixels exhibiting abnormal outputs are dispersed and displayed as noise on an image. On the other hand, there is a merit that since the computation processing amount decreases, it is possible to quickly display an image.

If spatial defect correction is selected in step S305, the process advances to step S306. A merit of spatial defect correction as the second defect correction is that even if the user feels a low image quality of an image having undergone the first defect correction using spatial defect correction, using spatially neighboring pixels will help him or her comprehend the contents of the image look degree. In addition, the spatial defect correction method has been repeatedly improved to make images look more naturally. For example, this method can effectively correct defects such as a continuous defect and a line defect.

If temporal defect correction is selected in step S305, the process advances to step S307. Temporal defect correction is defect correction performed based on the pixel values of pixels which are identical to a pixel exhibiting an abnormal output and obtained from temporally adjacent frames. When displaying an image in real time, it is desirable to use pixels identical to those in the immediately preceding frame. When playing back an image repeatedly or performing display processing for diagnosis, it is desirable to perform this temporal defect correction by using adjacent frames at the same proportions.

If defect correction using both temporal defect correction and spatial defect correction is selected in step S305, the process advances to step S308. In step S308, the apparatus executes defect correction by temporal defect correction and spatial defect correction upon weighting. In step S309, the apparatus performs image processing for display. Image processing for display is divided into tone processing, frequency processing, and pixel count processing. Tone processing is processing for adjusting the density of interest of a captured image to match the display tone of a monitor or the like. Frequency processing is frequency enhancement processing for properly expressing the frequency of interest of a captured image. Pixel count processing includes binning processing and cutting processing. In general, since a 1024-pixel image or 2048-pixel image is often displayed on a monitor or the like, the apparatus performs processing for changing the number of pixels to that suitable for display. If it is decided in step S310 that imaging is to be continued (YES in step S310), the process returns to step S310 to repeat the same processing as described above. If it is decided in step S310 that imaging is not continued (NO in step S310), the process advances to step S311 to execute display (output) processing for the image having undergone the image processing executed in step S309. The processing is then terminated.

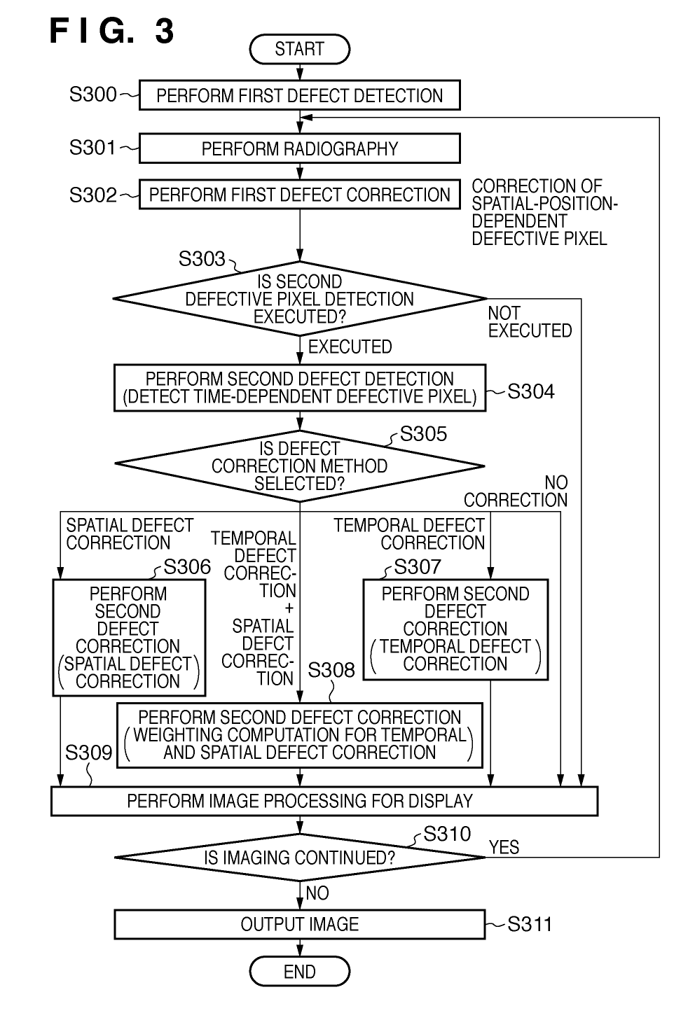

A statistic distribution obtained when X-ray photons mix with visible light photons and interact with each other will be exemplified with reference to FIG. 4. Reference numeral 4a in FIG. 4 denotes a graph for explaining a case in which the dose is low. Reference numeral 4b in FIG. 4 denotes a graph for explaining a case in which the dose is high to some extent. In the case denoted by reference numeral 4a in FIG. 4, since the dose is low, the number of X-ray photons which interact with each other is very small. For this reason, only pixels where X-ray photons have interacted with each other probabilistically appear as noise which is seen like defective pixels in the image. In contrast, if the dose is high as in the case denoted by reference numeral 4b in FIG. 4, as a plurality of X-ray photons interact with each other in each pixel, each pixel acts as if it were an X-ray photon counter. As a consequence, the respective pixels represent the distribution of the doses of X-rays transmitted through the object. This phenomenon depends on not only the doses but also the sensitivity of the X-ray flat panel detector (FPD) in which photoelectric conversion occurs. When noise in the radiographic system including the X-ray flat panel detector (FPD) is small, it is possible to reduce the dose assigned in a pixel value unit which can be detected by increasing the sensitivity of the X-ray flat panel detector (FPD). That is, when the amount of noise in the radiographic system is very small, it is possible to greatly reduce the minimum unit of a voltage or current to be assigned to each pixel when each photon is photoelectrically converted. This increases, in an indirect type radiation flat panel detector (FPD), the probability that X-rays transmitted through the phosphor, instead of light converted into visible light, will be directly photoelectrically converted by the radiation flat panel detector (FPD) and recognized as shot noise.

When the amount of noise in the radiation flat panel detector (FPD) is very small, since the X-ray dose increases as a higher sensitivity is set, the number of pixels recognized in an image upon direct photoelectric conversion of X-rays increases. This is because, if the quantity of X-ray photons directly photoelectrically converted in the radiation flat panel detector (FPD) is small, for example, one or less, a pixel in which photoelectric conversion has accidentally occurred appears as shot-like noise like a pixel whose pixel value has abruptly increased. As the X-ray dose increases, one or more X-ray photons are photoelectrically converted in every pixel. Finally, the distribution approaches a Gaussian distribution. Such X-ray shot noise is the result of visualization of photoelectric conversion when X-rays accidentally strike a pixel which is not a defective pixel by itself but is a normal pixel.

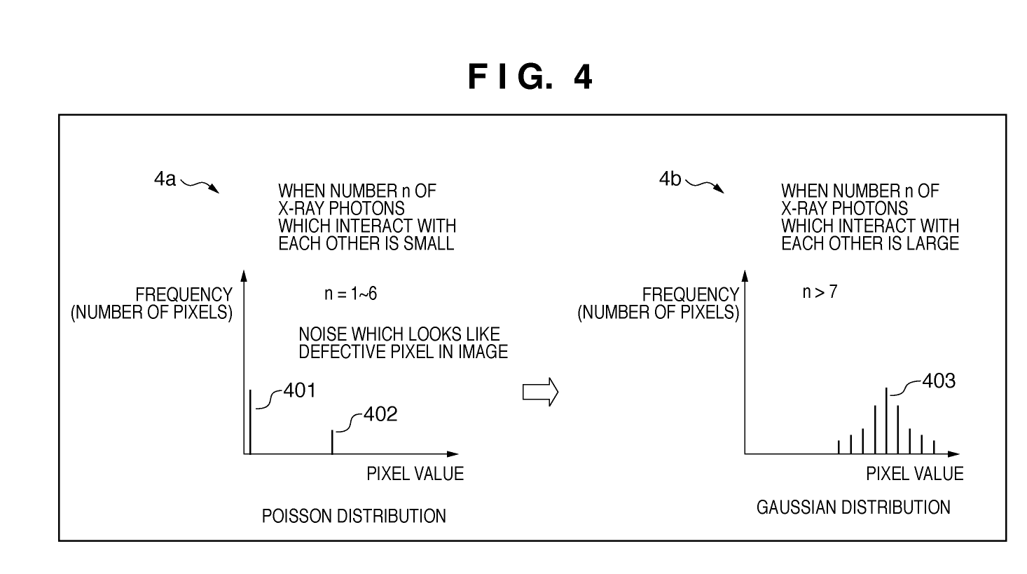

An abnormal pixel correction method will be conceptually described with reference to FIGS. 5A and 5B. FIG. 5A is a graph for exemplarily explaining normal and abnormal pixels. Abnormal pixels are classified into permanently abnormal pixels and temporarily abnormal pixels. The abscissa represents the lapse of time, and the ordinate, the pixel values of the (n−2)th, (n−1)th, nth, and (n+1)th image frames. Although the output value of a normal pixel slightly changes in accordance with the movement of the object, the dose of X-rays generated, or the like, the pixel value does not greatly change. In contrast to this, a permanently abnormal pixel always has a pixel value greatly different from the values of spatially neighboring pixels, and the overall pixel value of the abnormal pixel is small. In general, a temporarily abnormal pixel cannot be discriminated from a normal pixel, but sometimes outputs a value greatly different (smaller) from the pixel values of spatially neighboring pixels in a given frame (for example, the nth frame).

FIG. 5B is a view showing a defect correction method corresponding to an imaging frame rate. Reference numeral 501 denotes a view showing an example in which a temporarily defective pixel is generated during still image capturing. In this case, as in the prior art, the defect correction method decision unit 1020 selects a correction method so as to correct a defective pixel by using spatially neighboring pixels. If the number of pixels generated is small, the defect correction method decision unit 1020 can decide not to perform the second defective pixel correction. For example, it is possible to control a weighting setting to avoid the second defective pixel correction by setting a spatial/temporal defect correction weight to 0.

Reference numeral 502 denotes an example in which a temporarily defective pixel is generated in an image captured at a high moving image frame rate. The defect correction method decision unit 1020 decides to perform temporal defect correction using the pixel values of identical pixels in adjacent frames. In this case, for example, the defect correction method decision unit 1020 can also decide to perform defect correction using the pixel values of identical pixels in adjacent frames upon increasing the temporal defect correction weight. Reference numeral 503 denotes an example in which a temporarily defective pixel is generated in an image captured at an intermediate/low moving image frame rate. The defect correction method decision unit 1020 corrects a defective pixel by executing a correction method as a combination of a spatial defect correction method and a temporal defect correction method using spatially neighboring pixel values in the same image and pixel values in adjacent frame images. For example, the weighting control unit 1023 sets weights for spatial defect correction and temporal defect correction based on the decision result obtained by the defect correction method decision unit 1020. This apparatus executes a correction method as a combination of a spatial defect correction method and a temporal defect correction method based on the set weights.

This embodiment can provide a radiographic apparatus which can choose between a spatial parameter and a temporal parameter for correcting a temporarily defective pixel. The embodiment can also provide a radiographic apparatus which can change to a suitable correction method for an abnormal pixel which does not always appear, like an X-ray shot noise pixel or an abnormal dot pixel, in accordance with imaging conditions.

### Second Embodiment

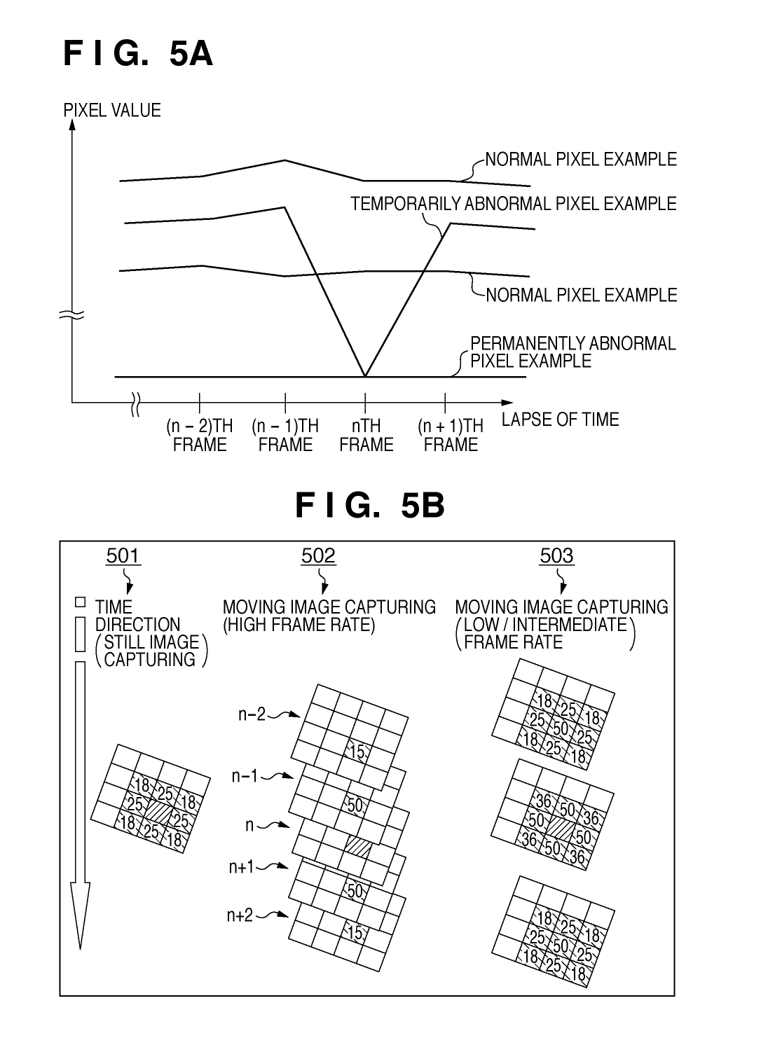

This embodiment will exemplify an arrangement for changing the second defect correction method by using an X-ray dose as information acquired at the time of imaging. The influences of X-ray shot noise corresponding to an X-ray dose on image quality will be exemplarily described with reference to FIG. 6. Reference numeral 6a in FIG. 6 denotes a case in which since the random noise amount is large, even if a pixel exhibiting an X-ray shot noise peak is input, the pixel is buried in random noise. This makes it difficult to recognize the pixel as a temporarily defective pixel. Reference numeral 6b in FIG. 6 denotes a case in which since the random noise amount is small, when a pixel exhibiting an X-ray shot noise peak is input, the pixel is not buried in random noise. This makes it easy to recognize the pixel as a temporarily defective pixel. The present invention performs proper defect correction by performing control based on the magnitude of the random noise amount to decide whether to perform temporary defect correction for an X-ray shot noise pixel.

Reference numeral 6c in FIG. 6 denotes a graph exemplarily showing the relationship between X-ray doses and random noise amounts. The abscissa represents X-ray doses, and the ordinate, pixel values corresponding to the random noise amounts of components which randomly vary in the image. As indicated by the graph denoted by reference numeral 6c, in general, as the X-ray dose increases, both the pixel value (average value) and the random noise amount monotonously increase. The X-ray shot noise is overwhelmingly smaller than the pixel value (average value) and the random noise amount, and hence has no influence in a broad sense. Even if the number of X-ray shot noise pixels is small, since the peak pixel value of each pixel is large, it tends to be noticeable when the random noise amount is small. This embodiment performs the second defect correction to make X-ray shot noise less noticeable relative to random noise when the X-ray dose is equal to or less than a threshold.

An X-ray dose threshold will be described next. Whether one pixel value is visually recognized in random noise depends on whether the value falls within the range of about 1/7 to about 1/10 the X-ray dose. In the case of the penetration dose of an X-ray dose, in which if the pixel value of X-ray shot noise is 100 LSB (Least Significant Bit), the pixel value of random noise is about 15 LSB or less, which is 1/7 that of the X-ray shot noise, a defect correction method decision unit 1020 decides to perform the second defect correction. In the case of a dose equal to or more than the entrance dose, the corresponding pixel is unnoticeable and is not completely a defective pixel. This pixel includes some correct pixel value, to which only a pixel value of as small as about 100 LSB is added. In this case, therefore, the defect correction method decision unit 1020 does not regard the pixel as a defective pixel. That is, the defect correction method decision unit 1020 decides not to perform the second defect correction.

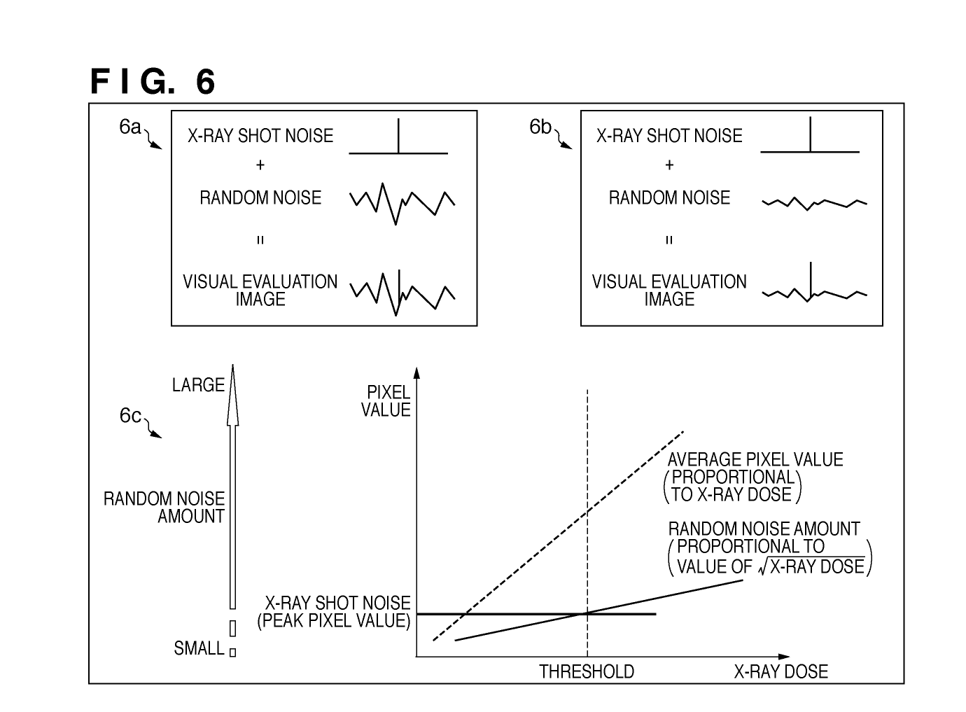

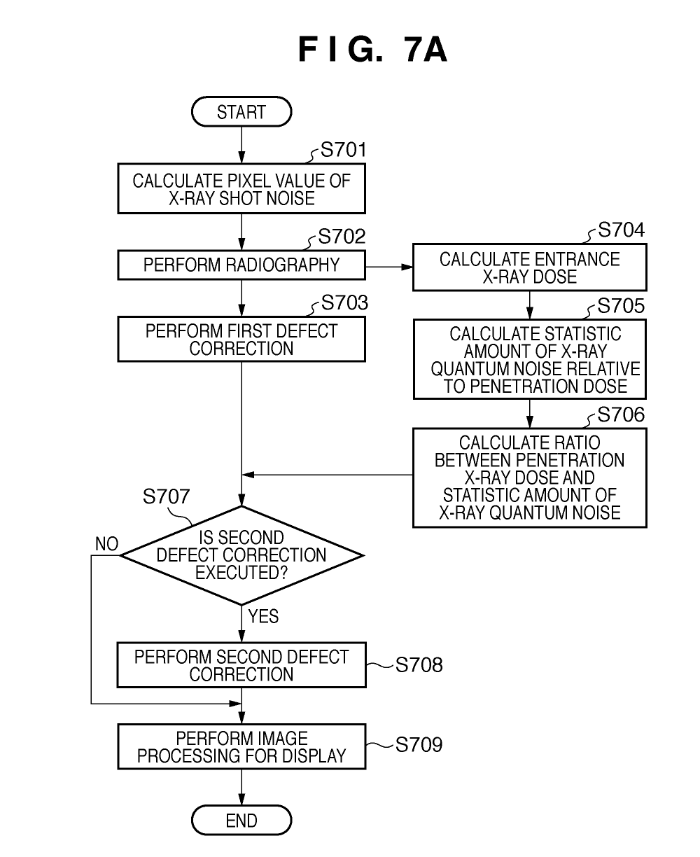

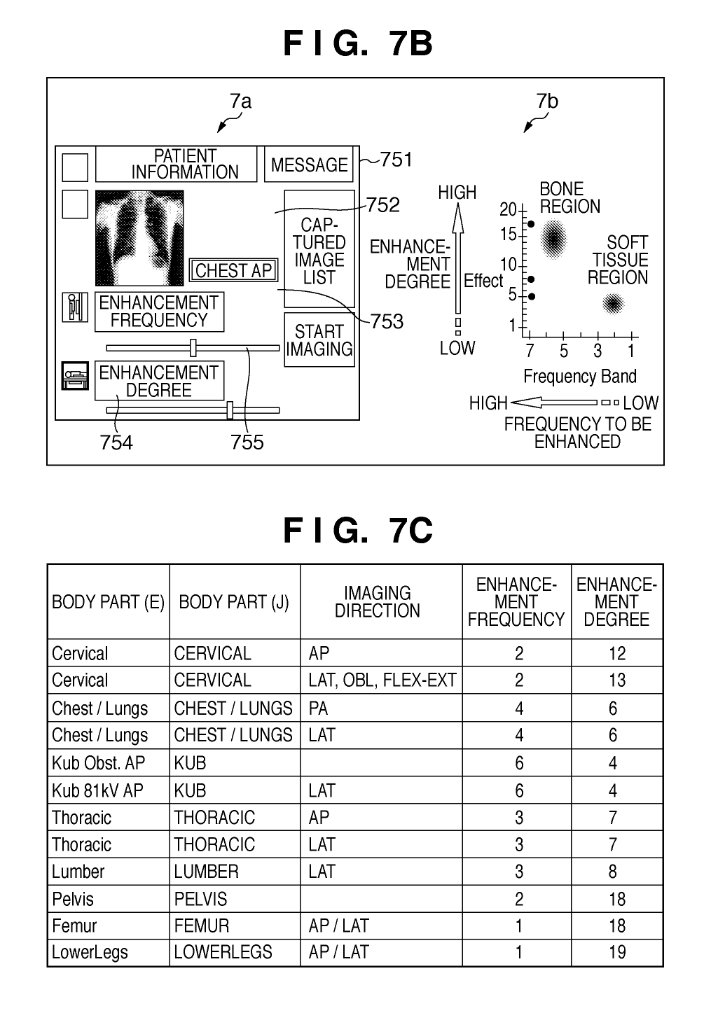

A processing procedure in the radiographic apparatus according to the second embodiment will be described with reference to FIG. 7A. In step S701, the apparatus calculates the pixel value of X-ray shot noise. The statistic value of pixel outputs when X-ray shot noise occurs is stored in advance in the storage unit before, for example, shipment. For example, in an indirect type FPD, pixel values are read from the phosphor before it is bonded by reading electric charges accumulated in the phosphor by irradiating it with only X-rays in an environment in which no visible light enters it. Using this method can calculate the statistic value of only output pixel values of X-ray shot noise in advance.

In step S702, the apparatus captures an X-ray image. This processing is the same as that in step S301 in FIG. 3. In step S703, the apparatus executes the first defect correction. The apparatus performs the first defect correction using spatially neighboring pixels for the X-ray image captured in step S702 in the same manner as described in the first embodiment. The process advances to step S707.

In step S704, the apparatus analyzes the X-ray image captured in step S702 to calculate a penetration X-ray dose. It is possible to calculate this penetration X-ray dose based on each pixel value detected by an X-ray detection unit 1004. The pixel value decreases in a thick region of an object, in the X-ray irradiation direction, through which X-rays are transmitted for a large distance, and increases in a thin region of the object through which X-rays are transmitted for a small distance.

In step S705, the apparatus calculates the statistic amount of X-ray quantum noise with respect to the entrance X-ray dose. Since random noise amounts are obtained in advance as indicated by the ordinate and abscissa denoted by reference numeral 6c, the apparatus executes conversion processing by using them as a conversion table.

In step S706, the apparatus calculates the ratio between the pixel value of X-ray shot noise and the statistic amount of random noise amounts. In general, as denoted by reference numerals 6a and 6b, since the visual recognition limit falls within the range of 1/7 to 1/10 the random noise amount, the apparatus calculates and outputs the ratio of the two values.

In step S707, the defect correction method decision unit 1020 decides, based on the ratio calculated in step S706, whether to execute the second defect correction. When a temporarily defective pixel occurs at neighboring pixel values at which the doses are larger than, for example, 1/7 the random noise amount, there is a possibility that the corresponding pixel cannot be visually recognized. For this reason, the defect correction method decision unit 1020 decides not to perform the second defect correction. In this case, the process advances to step S709. If a temporarily defective pixel occurs at neighboring pixel values at which the doses are smaller than the dose (threshold) at which the ratio of the X-ray dose to the random noise is, for example, 1/7, the defect correction method decision unit 1020 decides to execute the second defect correction.

In step S707, a second defect correction unit 1011 executes the second defect correction. In step S709, the apparatus executes image processing for display, and displays (outputs) the captured X-ray image on a film, monitor, or the like. The processing is then terminated. Note that the numerical values 1/7 and 1/10 described as the thresholds in this embodiment are merely examples indicating visual recognition limits. Obviously, the gist of the present invention is not limited to these examples of numerical values.

According to this embodiment, it is possible to change the second defect correction method by using an X-ray dose as information acquired at the time of imaging.

### Third Embodiment

This embodiment will exemplify an arrangement for controlling the contents of the second defect correction by using body part information input or detected by a radiographic apparatus, which is information acquired at the time of imaging (information acquired at imaging). Reference numeral 7a in FIG. 7B denotes an example of an operation window on the radiographic apparatus. Reference numeral 7b in FIG. 7B denotes a graph exemplarily showing the relationship between enhancement frequencies and enhancement degrees in a bone region and soft tissue region as body parts. FIG. 7C is a view exemplarily showing the relationship between an enhancement frequency and an enhancement degree for each body part. The radiographic apparatus performs proper image processing in accordance with the body part (for example, the chest AP) designated on the operation window at the time of imaging. The image processing in this case basically includes tone processing and frequency processing. This embodiment uses set parameters in frequency processing. The set parameters in frequency processing include, for example, an enhancement frequency and an enhancement degree as shown in FIG. 7C. The radiographic apparatus stores enhancement frequencies each indicating the frequency to be enhanced for each body part and enhancement degrees. It is possible to arbitrarily change an enhancement frequency parameter and an enhancement degree parameter.

Reference numeral 7b denotes a graph showing the relationship (distribution) between enhancement frequencies and enhancement degrees in a bone region and soft tissue region as body parts. In a diagnosis image, a soft tissue region is often subjected to weak enhancement amount processing with a low enhancement frequency. In contrast, a bone region is often subjected to enhancement processing with a high enhancement degree and a high enhancement frequency. Enhancement parameters for frequency processing for other body parts generally fall between parameters for the above body parts. Checking image processing parameters for frequency enhancement in this manner allows to grasp a specific spatial frequency of interest in accordance with each body part of each captured image. In this embodiment, the defect correction method decision unit 1020 decides, in accordance with whether the spatial frequency of interest is a high spatial frequency or a low spatial frequency, whether to place importance on spatial defect correction or temporal defect correction in the second defect correction method.

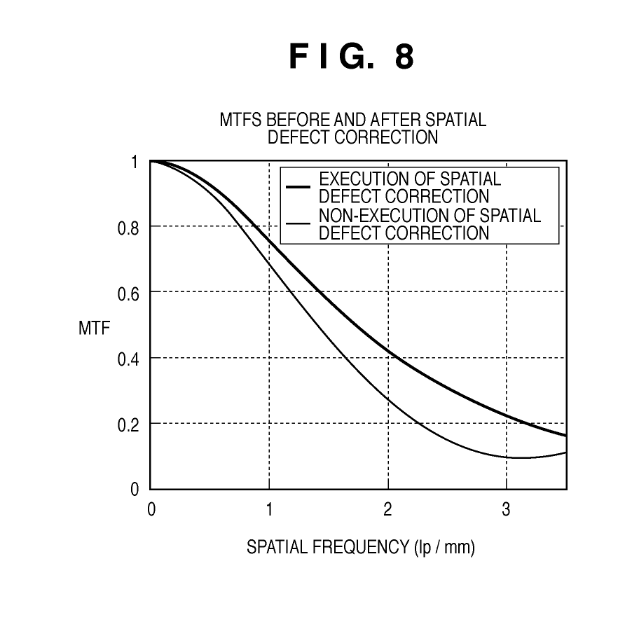

The relationship between spatial frequencies and MTFs (Modulation Transfer Functions) will be exemplarily described with reference to FIG. 8. FIG. 8 shows the spatial frequency dependence of an MTF decrease at the time of execution of spatial defect correction. When spatial defect correction is performed with spatially neighboring pixels, the corresponding pixel spatially blurs because its pixel value is determined by using neighboring pixels instead of the original value of the pixel. FIG. 8 shows an example of this state with MTFs. An MTF decrease before and after spatial defect correction is small at low spatial frequencies, whereas an MFT decrease is large at high spatial frequencies. Referring to FIG. 8, when the frequency of interest in a designated body part is a high spatial frequency, the apparatus controls the contents of the second defect correction method so as to increase the temporal defect correction weight and decrease the spatial defect correction weight in order to prevent a large decrease in the MTF of the frequency of interest.

In contrast, when the frequency of interest is a low spatial frequency, the apparatus controls the contents of the second defect correction method so as to decrease the temporal defect correction weight and increase the spatial defect correction weight. Controlling the contents of the second defect correction method in this manner can execute the second defect correction method whose contents are suitable to the characteristics of a designated body part.

Although this embodiment has exemplified the case in which the operator designates a body part on the operation window, the gist of the present invention is not limited to this. Obviously, for example, the present invention can also be applied to a case in which an image is analyzed on software by using a support vector machine to recognize a body part, and the obtained body part is input. In addition, this embodiment allows the present invention to be applied to obtaining a frequency of interest based on a body part. However, the gist of the present invention is not limited to this. Obviously, it is also possible to input a frequency of interest and spatial defect correction and temporal defect correction weights in advance via an operation window or the like.

According to this embodiment, it is possible to control the contents of the second defect correction by using body part information input or detected by a radiographic apparatus, which is information acquired at the time of imaging (information acquired at imaging).

### Fourth Embodiment

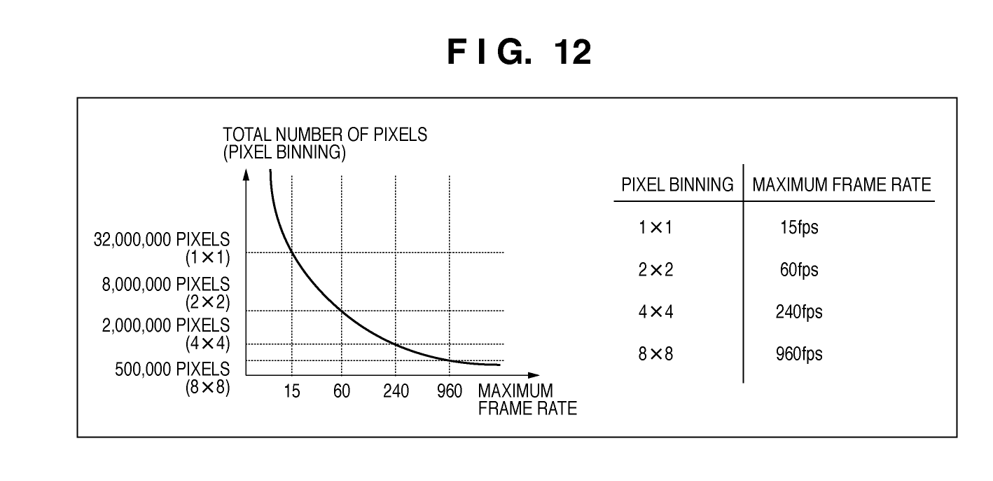

This embodiment will exemplify an arrangement for controlling the contents of the second defect correction by using an imaging frame rate of the information acquired at the time of imaging (information acquired at imaging). The relationship between maximum frame rates and the total numbers of pixels (pixel binning) will be exemplarily described with reference to FIG. 12. In general, as the imaging frame rate increases, the total number of pixels decreases. There is available a method of reducing the total number of pixels by cutting part of an image or performing pixel binning. Performing pixel binning will increase the distances to spatially neighboring pixels. That is, in general, in many cases, imaging at a high frame rate is performed together with pixel binning or the like. In performing pixel binning, since the distances between pixel regions each including a cluster of pixels increase (spatially neighboring pixels become farther), it is preferable to control the contents of the second defect correction so as to reduce the spatial defect correction weight. In addition, as the imaging frame rate increases, the temporal changes of neighboring pixels decrease (temporally neighboring pixels become closer). For this reason, it is preferable to control the contents of the second defect correction so as to increase the temporal defect correction weight.

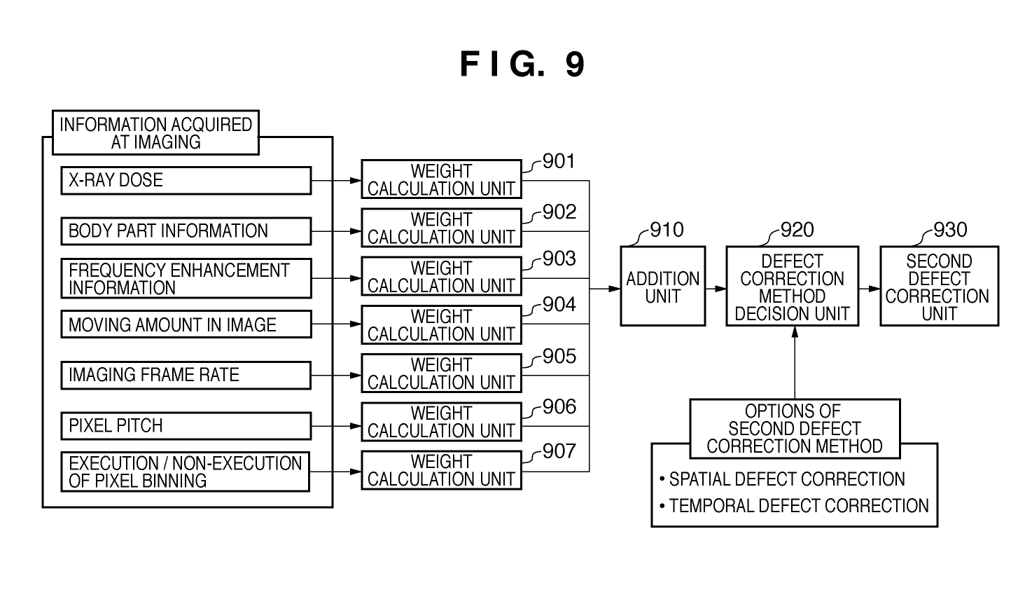

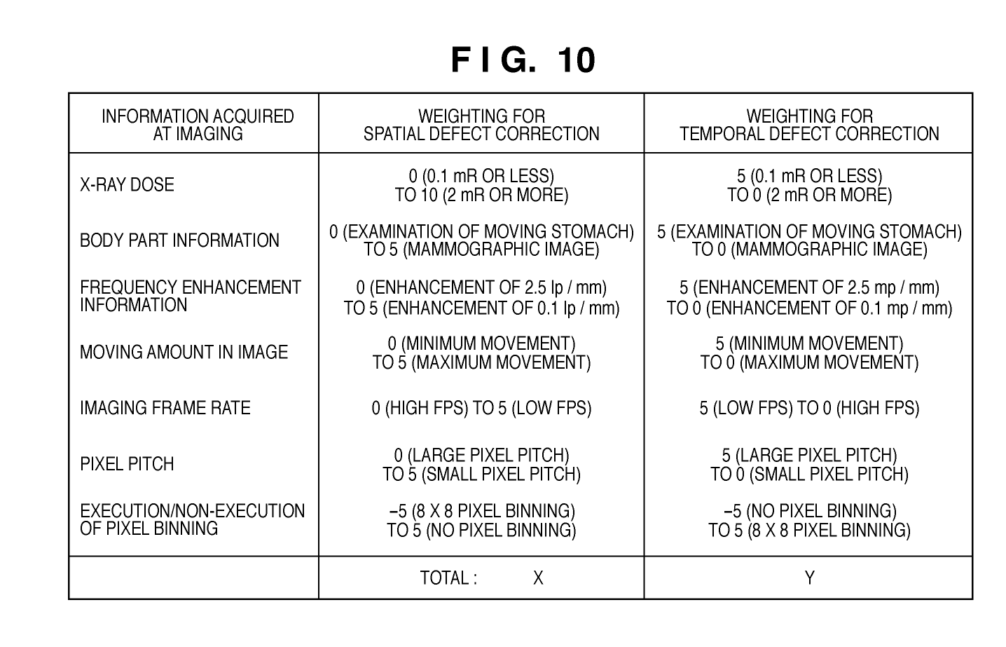

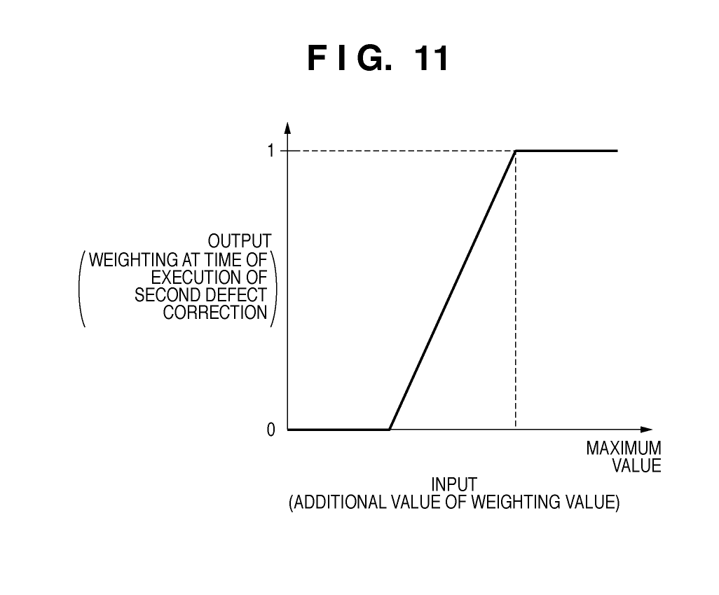

The arrangement of a weight calculation unit for the information acquired at the time of imaging (information acquired at imaging) will be described with reference to FIG. 9. The information acquired at the time of imaging includes information such as an X-ray dose, body part information, frequency enhancement information, a moving amount in an image, an imaging frame rate, a pixel pitch, information indicating the execution/non-execution of pixel binning, and an X-ray random noise amount. Weight calculation units 901 to 907 calculate weighting information for at least one of these pieces of information. Depending on the information acquired at the time of imaging, it is proper to increase the spatial defect correction weight, and it is also proper to increase the temporal defect correction weight. For example, this is the case in which a fast moving object (to be described later) is imaged at a high frame rate. In this case, the weight calculation units 901 to 907 independently calculate pieces of weighting information for the respective pieces of information acquired at imaging by using the respective pieces of information acquired at imaging. The weight calculation units 901 to 907 output the weighting information calculation results to a weighting table like that shown in FIG. 10. An addition unit 910 obtains weighting information corresponding to spatial defect correction and weighting information corresponding to temporal defect correction by adding and combining the values of the respective pieces of weighting information, and outputs the pieces of information to a defect correction method decision unit 920. The defect correction method decision unit 920 selects a correction method from the options of the second defect correction method and controls the contents of correction. The options include, for example, spatial defect correction and temporal defect correction. If the pieces of weighting information for spatial defect correction and temporal defect correction are set to 0, the apparatus performs neither of the two types of correction. That is, the options include the non-execution of the second defect correction. The relationship between an additional value (input) of weighting information and an output value of weighting information at the time of execution of the second defect correction will be described with reference to FIG. 11. The defect correction method decision unit 920 determines a weighting value (output) at the time of execution of the second defect correction based on an input value of each piece of weighting information input from the addition unit 910. If, for example, the output is “0” or “1”, the defect correction method decision unit 920 determines a correction method so as to execute either spatial defect correction or temporal defect correction. If the output satisfies 0<output<1, for example, output=0.5, the defect correction method decision unit 920 controls the contents of the second defect correction so as to perform spatial defect correction at a ratio of 50% and also perform temporal defect correction at a ratio of 50%. Note that if either of the weights is excessively large, it is preferable in terms of calculation time and real-time performance to perform defect correction by using only one method. A second defect correction unit 930 executes the contents of correction based on the weight output decided and determined by the defect correction method decision unit 920.

According to this embodiment, it is possible to control the contents of the second defect correction by using an imaging frame rate of the information acquired at the time of imaging (information acquired at imaging).

### Fifth Embodiment

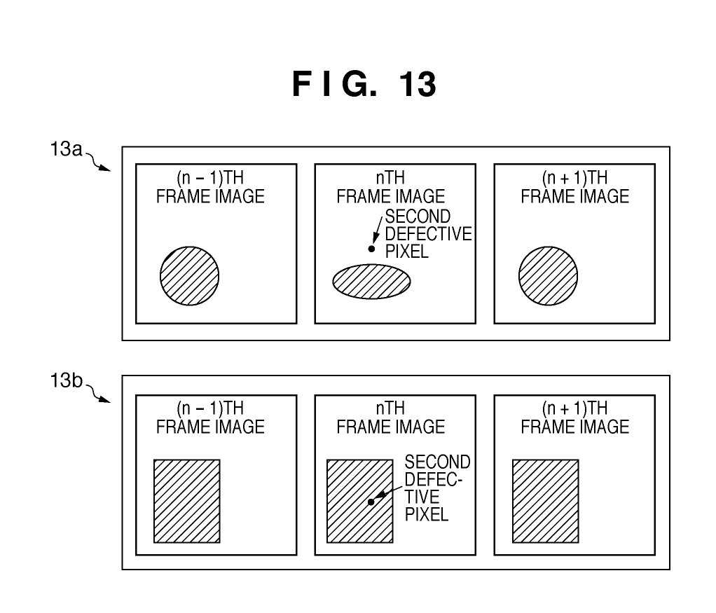

This embodiment will exemplify an arrangement for controlling the contents of the second defect correction by detecting the moving amount of a pixel position in an image, of the information acquired at the time of imaging (information acquired at imaging). FIG. 13 exemplarily shows images in which the movement of objects varies in amount. Reference numeral 13a denotes an example of the (n−1)th to (n+1)th frame images of an object with a large moving amount. Reference numeral 13b denotes an example of the (n−1)th to (n+1)th frame images of an object with a small moving amount. An object with a large moving amount is, for example, the heart in a living body. The lungs and the like in a living body periodically move, and hence are objects with moving amounts. In addition, a contrast medium for the stomach used for Magen imaging or the like is also an object with a moving amount. An object with a small moving amount is, for example, a region such as a limb which is located apart from the heart and lungs and includes many bones and the like in an X-ray image. This apparatus changes the second defect correction method or its weighting depending on whether a temporally abnormal pixel value is generated in a pixel in a region of the object with a large moving amount denoted by reference numeral 13a or in a pixel in a region of the object with a small moving amount denoted by reference numeral 13b.

Assume that a temporally abnormal pixel value is generated in a pixel in a region of the object with a large moving amount denoted by reference numeral 13a. In this case, if this apparatus performs defect correction with the average value of identical pixels which are temporally neighboring pixels in adjacent frames ((n−1)th and (n+1)th frames), the output after defect correction of the nth frame becomes a pixel value greatly different from those of spatially neighboring pixels. This result indicates that spatial defect correction cannot be properly performed by using temporally neighboring pixels.

This embodiment therefore controls the defect correction method so as to select the non-execution of temporal defect correction or decrease the corresponding weight when a moving amount is detected in a region spatially surrounding a detected temporarily defective pixel, and an object with a large moving amount like that denoted by reference numeral 13a is detected near the temporarily defective pixel.

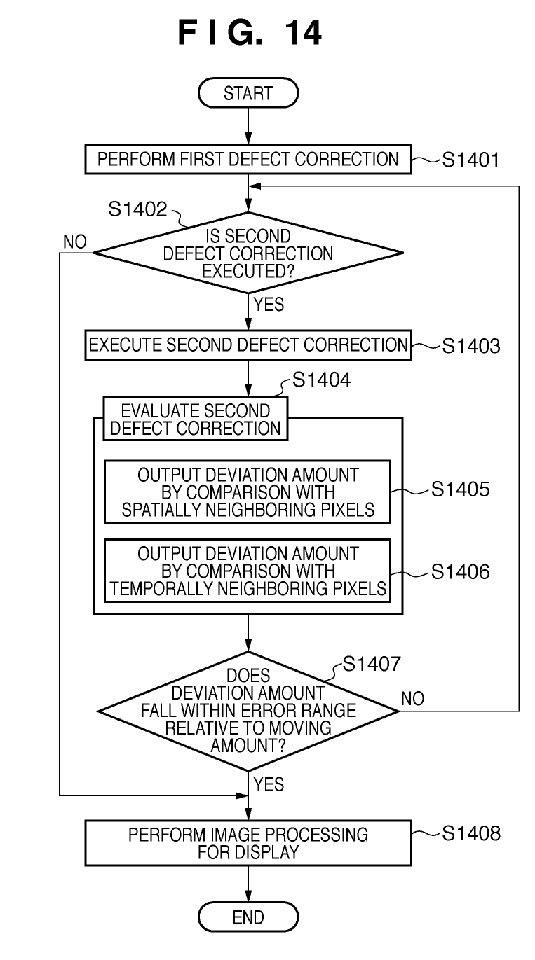

A processing procedure in the radiographic apparatus according to the fifth embodiment will be described with reference to FIG. 14. In step S1401, the apparatus executes the first defect correction. After the image captured by radiography undergoes the first defect correction using spatially neighboring pixels as described in the first embodiment, the process advances to step S1402. Based on the information acquired at the time of imaging (information acquired at imaging), a defect correction method decision unit 1020 decides whether to execute the second defect correction. When the defect correction method decision unit 1020 decides not to execute the second defect correction, the process advances to step S1408 to execute image processing for display. If the defect correction method decision unit 1020 decides in step S1402 to execute the second defect correction, the process advances to step S1403 to control the settings for the second defect correction. In this step, the apparatus calculates weighting information for spatial defect correction and weighting information for temporal defect correction. Alternatively, the apparatus selects the non-execution of temporal defect correction, in other words, setting the weighting information for temporal defect correction to 0, or adjusts the settings of weighting information so as to decrease or increase the weight.

In step S1404, the apparatus evaluates the result of the second defect correction. The evaluation step (S1404) includes steps S1405 and S1406. In step S1405, the apparatus compares the pixel values of neighboring pixels (the values of spatially neighboring pixels) of the pixel in which a pixel value abnormality is detected, and outputs the deviation amount calculation result. In this case, a CPU 1014 functions as the first deviation amount calculation means for calculating the deviation amount of spatial defect correction.

In step S1406, the apparatus compares the pixel values (the values of temporally neighboring pixels) of pixels which are identical to the pixel in which the pixel value abnormality is detected and are obtained from frames temporally located before and after the frame including the pixel in which the abnormality is detected, and outputs the deviation amount calculation result. The CPU 1014 functions as the second deviation amount calculation means for calculating the deviation amount of temporal defect correction.

In step S1407, the apparatus compares the moving amount of the pixel of interest as a correction target with each deviation amount, and decides whether each deviation amount falls within a predetermined error range (error decision). If the deviation amount falls outside the error range, the process returns to step S1402 to execute the same processing as described above. In step S1403, the apparatus resets at least one of the weighting information for spatial defect correction and weighting information for temporal defect correction so as to make the deviation amount fall within the error range. If it is decided by error decision that the deviation amount of spatial defect correction exceeds the error range, weight calculation units 901 to 907 and an addition unit 910, which function as calculation means, reset the weighting information for spatial defect correction. If it is decided by error decision that the deviation amount of temporal defect correction exceeds the error range, the weight calculation units 901 to 907 and the addition unit 910 reset the weighting information for temporal defect correction. A second defect correction unit 1011 then executes the correction method as a combination of spatial defect correction and the temporal defect correction based on the reset weighting information.

If it is decided in step S1407 that the deviation amount falls within the error range, the process advances to step S1408 to execute image processing for display. The processing is terminated.

According to this embodiment, it is possible to control the contents of the second defect correction by detecting the moving amount of a pixel position in an image of the information acquired at the time of imaging (information acquired at imaging).

### Sixth Embodiment

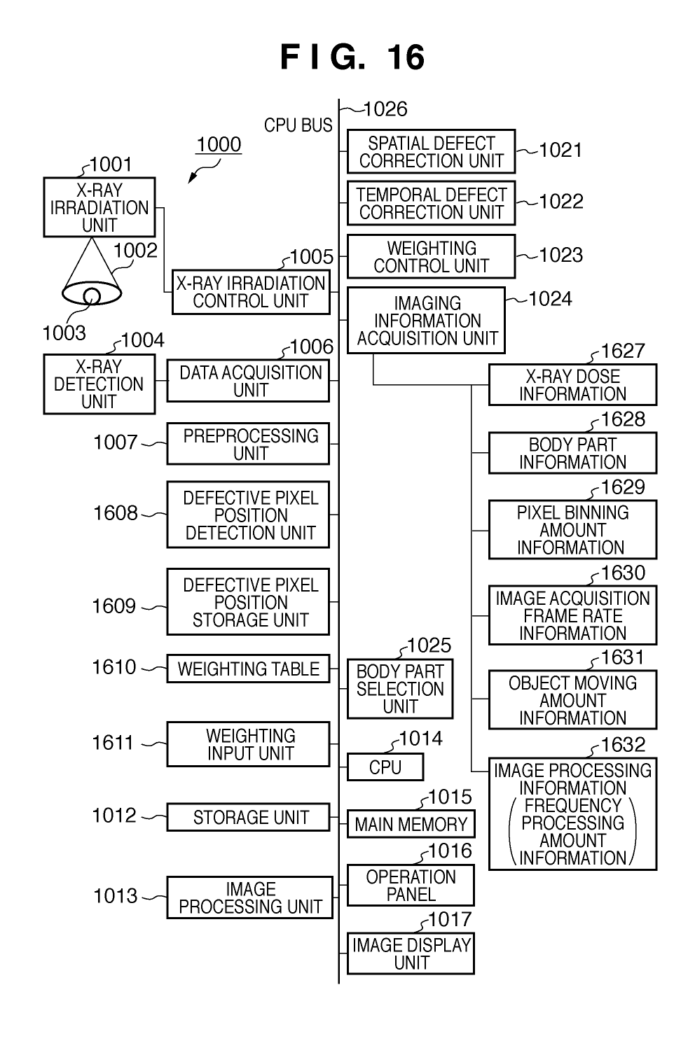

The arrangement of a radiographic apparatus according to the sixth embodiment will be described with reference to FIG. 16. The same reference numerals as in FIG. 1 denote the same parts in FIG. 16, and a repetitive description will be omitted.

A defective pixel position detection unit 1608 stores, in a defective pixel position storage unit 1609, the position information of the permanently defective pixel detected by an X-ray detection unit 1004, together with a defective pixel extraction mode. A spatial defect correction unit 1021 corrects a defective pixel in each image stored in a memory 1015 by using the pixel values of spatially neighboring pixels, and stores each defect position in a storage unit 1012.

When the user inputs an imaging instruction via an operation panel 1016, the contents of the imaging instruction are stored in the storage unit 1012 and displayed on the operation panel 1016. When the imaging instruction is issued, a specific body part is selected by a body part selection unit 1025 via the operation panel 1016.

An imaging information acquisition unit 1024 stores body part information 1628 selected by the body part selection unit 1025. The imaging information acquisition unit 1024 stores image processing information 1632 such as enhancement frequencies and enhancement degrees in spatial frequency processing which are adjusted for each body part in accordance with the body part information selected by the body part selection unit 1025.

The preprocessed X-ray image data is transferred as original image data to the main memory 1015 via a CPU bus 1026 under the control of a CPU 1014. The spatial defect correction unit 1021 performs defect correction by using spatially neighboring pixels and the defective pixel position map stored in the defective pixel position storage unit 1609 at the time of shipment. The obtained image data is transferred to the main memory 1015 via the CPU bus 1026 under the control of the CPU 1014. The main memory 1015 stores a program for causing a computer to execute a control method for the radiographic apparatus.

The apparatus then extracts a defect from each obtained image data by using a defective pixel position detection unit 1608. The defective pixel position storage unit 1609 stores the obtained defective pixel position together with the defective pixel extraction mode. The defective pixel position detection unit 1608 extracts a temporarily defective pixel for each image such as an X-ray shot noise pixel generated by interaction between X-ray photons or an abnormal dot pixel generated when, for example, noise accidentally mixes in the semiconductor X-ray detector.

The spatial defect correction unit 1021 and a temporal defect correction unit 1022 perform defect correction for the detected defective pixel in accordance with weighting controlled by a weighting control unit 1023 for spatial/temporal defect correction.

The weighting control unit 1023 sets weighting information based on any one of the information in the defective pixel position storage unit 1609, the information in the imaging information acquisition unit 1024, the information from a weighting input unit 1611, and a weighting table 1610. The weighting control unit 1023 can control settings so as to change each of the set values of weighting information for spatial defective pixel correction and weighting information for temporarily defective pixel correction based on, for example, the information acquired at the time of imaging the object.

The defective pixel position storage unit 1609 stores, for example, for each pixel, a defective pixel extraction mode indicating the mode of extracting a permanently defective pixel or the mode of extracting temporarily defective pixel which appears temporarily or in accordance with a dose. The imaging information acquisition unit 1024 stores X-ray dose information 1627 obtained from the pixel value detected by the X-ray detection unit 1004, the body part information 1628, pixel binning amount information 1629, image acquisition frame rate information 1630, object moving amount information 1631, and the like. The weighting control unit 1023 performs control to decide by which weight spatially/temporarily defective pixel correction is performed by using the defective pixel extraction mode stored in the imaging information acquisition unit 1024 and the defective pixel position storage unit 1609. The X-ray image data having undergone defective pixel correction processing is transferred as original image data to the main memory 1015 and an image processing unit 1013 via the CPU bus 1026 under the control of the CPU 1014. The image processing unit 1013 performs noise reduction processing, frequency processing, and tone processing, and outputs the resultant X-ray image data to an image display unit 1017.

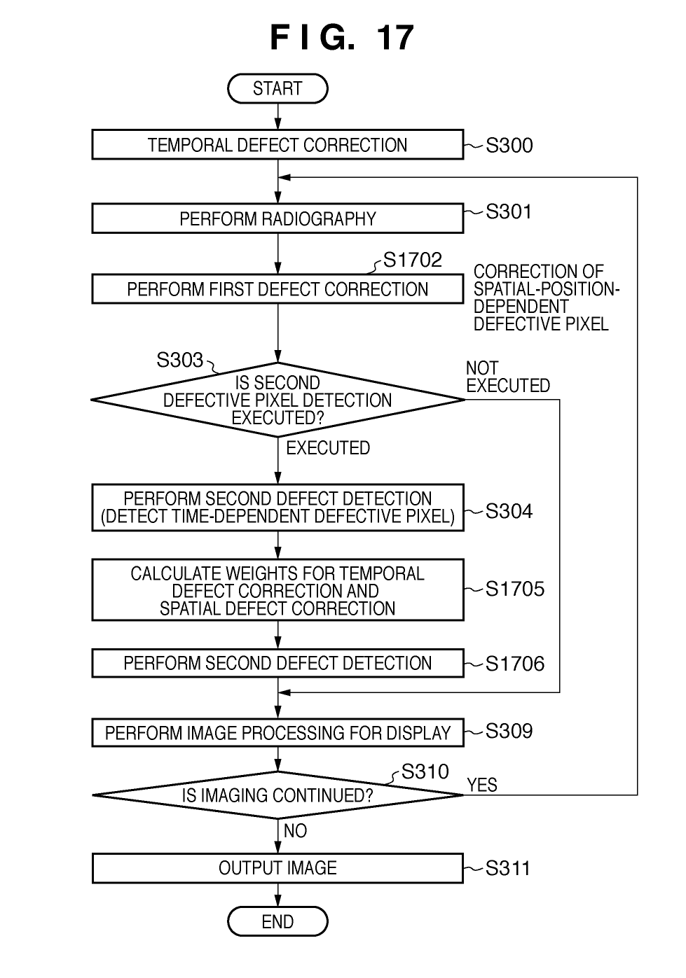

A processing procedure in the radiographic apparatus according to this embodiment will be described with reference to FIG. 17. A description of the same processing as that in the flowchart of FIG. 3 will be omitted.

In step S1702, the apparatus performs defective pixel correction (first defect correction) dependent on spatial positions. The defective pixel position storage unit 1609 stores, at the time of shipment, permanently defective pixel positions existing in the radiographic apparatus together with the defective pixel extraction mode. The apparatus performs defective pixel correction dependent on spatial positions by using a defective pixel position map indicating permanently defective pixel positions.

In step S1705, the apparatus calculates weights for temporal defect correction and spatial defect correction. The pixel detected by the first defect detection is a permanently defective pixel, and hence the temporal defect correction weight is set to 0 to perform defect correction using only spatially neighboring pixels. The apparatus also determines a defect correction method by using the information acquired at imaging. When the number of second defective pixels is very small, the step of detecting second defective pixels and performing the second defect correction takes much calculation time when displaying a moving image in real time. This may lead to a delay time before display. At this time, it is desirable to set both the temporal defect correction weight and the spatial defect correction weight to 0 so as not to perform defect correction.

If, however, a given image is to be repeatedly seen afterward or used for diagnosis or the like instead of being displayed in real time, any accidental defective pixel may spoil the displayed image or an analysis function for indicating tones can indicate an abnormal value. For this reason, the apparatus performs defective pixel correction by controlling temporal defect correction/spatial defect correction weights. It is when, for example, still image capturing is performed or the moving image frame rate is low that it is proper to perform defect correction upon increasing the weight for defect correction using spatially neighboring pixels. At this time, since there exists some time interval between adjacent frames, the object or the like may have greatly moved. In such a case, defect correction using adjacent frames results in defect correction using considerably different pixel values.

The following is a case in which it is proper to perform defect correction upon increasing the weight for defect correction using temporally neighboring pixels. At the time of imaging at a high frame rate, the pixel values of temporally neighboring pixels are sometimes higher in accuracy than those of spatially neighboring pixels. For example, this is the case when the object hardly moves. In such a case, the weight for defect correction using temporally neighboring pixels is increased. In addition, at the time of imaging at a high frame rate, settings are often made on the radiographic apparatus side so as to read out pixels upon binning. This is because, it takes much time to read out many pixels, and hence it is difficult to read out an image at a high frame rate. This is also because that image processing such as preprocessing becomes more difficult as the image size increases. Performing pixel binning will increase the distances to spatially neighboring pixels, and hence will further increase the necessity to perform defect correction using temporally neighboring pixels. When, for example, a high frame rate is to be set, and this apparatus performs, for example, 2×2 pixel binning or 4×4 pixel binning instead of reading out all the pixels, a pixel size with a pitch of 160 μm is virtually regarded as a pixel size with a pitch of 320 μm or 640 μm. At this time, performing defect correction using spatially neighboring pixels will lead to the necessity to perform defect correction using pixels at distant positions and will reduce the accuracy of defect correction. That is, when imaging is performed at a high frame rate, spatially neighboring pixels are located at more spatially distant positions while temporally neighboring pixels are located temporally closer to each other. Owing to such synergistic effect, the apparatus performs defect correction upon increasing the weight for defect correction using temporally neighboring pixels.

In step S1706, the apparatus performs spatial/temporal defect correction by using the weighting settings calculated and controlled in the previous step. In a broad sense, when either of the weights is set to 0, the apparatus performs only spatial defect correction or temporal defect correction. A merit of defect correction upon increasing the weight for spatial defect correction is that even if the user feels a low image quality of an image having undergone the defect correction, using spatially neighboring pixels will help him or her comprehend the contents of the image to some degree because he/she is used to the previous spatial defect correction. In addition, the spatial defect correction method has been repeatedly improved to make images look more natural. For example, since some contrivance is made to correct a continuous defect and a line defect, the maturity of a defect correction algorithm is the highest merit.

This embodiment can provide a radiographic apparatus which can choose between spatial parameter correction and temporal parameter correction for a temporarily defective pixel. The embodiment can also provide a radiographic apparatus which can change to a suitable correction method for an abnormal pixel which does not always appear, like an X-ray shot noise pixel or an abnormal dot pixel, in accordance with imaging conditions.

### Seventh Embodiment

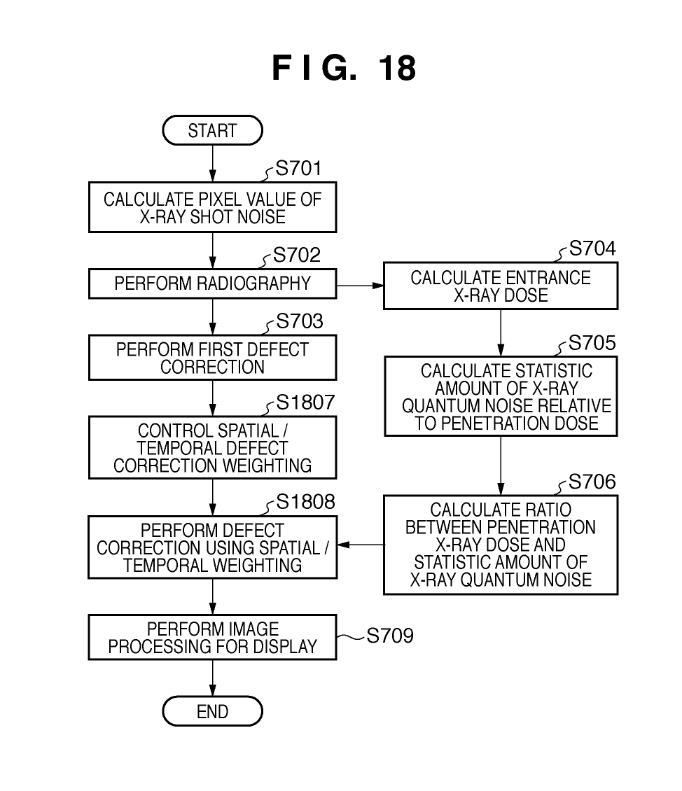

This embodiment will exemplify an arrangement for controlling spatial/temporal defect correction weighting by using an X-ray dose as information acquired at the time of imaging. A processing procedure in the radiographic apparatus according to the embodiment will be described with reference to FIG. 18. A description of processing common to that in FIG. 7A will be omitted.

In step S1807, the apparatus controls spatial/temporal defect correction weighting based on the ratio obtained in step S706. If a temporarily defective pixel is generated at neighboring pixel values at which the ratio obtained in step S706 is higher than that of the X-ray dose which is, fore example, 1/7, since there is a possibility that the pixel will not be seen, both the spatial defect correction weight and the temporal defect correction weight are set to 0. That is, the apparatus performs control not to perform defect correction. If, for example, a temporarily defective pixel is generated at neighboring pixel values at which the ratio is lower than that of the dose which is, for example, 1/7, the apparatus controls spatial/temporal defect correction weighting so as to increase the temporal defect correction weight.

In step S1808, the apparatus performs defect correction using spatial/temporally neighboring pixels in accordance with the weights obtained in the previous step.

According to this embodiment, it is possible to control spatial/temporal defect correction weighting by using an X-ray dose as information acquired at the time of imaging.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-115918, filed May 12, 2009, which is hereby incorporated by reference herein in its entirety.

1.-10. (canceled)

11. A radiographic apparatus including an X-ray irradiation unit configured to irradiate X-rays and an X-ray detection unit configured to detect an X-ray image of an object irradiated by said X-ray irradiation unit, the apparatus comprising:
a first defect detection unit configured to detect, as a position-dependent defect, a pixel, of a plurality of X-ray images detected by said X-ray detection unit, whose pixel value is always abnormal, and acquiring position information of the defect in the X-ray image;
a first defect correction unit configured to correct the pixel value of the pixel in which an abnormality is detected, based on the position information and a pixel value of a neighboring pixel of the pixel in which the abnormality of the pixel value is detected;
an acquisition unit configured to acquire information indicating an imaging condition for the object when said X-ray detection unit detects the X-ray image;
a decision unit configured to decide, based on the information indicating the imaging condition acquired by said acquisition unit, whether to further correct the X-ray image corrected by said first defect correction unit;
a second defect detection unit configured to, when said decision unit decides to further correct the X-ray image, detect as a defect a pixel, of the plurality of X-ray images detected by said X-ray detection unit, which temporarily becomes abnormal dependent on a lapse of time;
a determination unit configured to determine a correction method for correcting the pixel value of the pixel in which the abnormality is detected by said second defect detection unit, based on the information indicating the imaging condition; and
a second defect correction unit configured to correct the pixel value of the pixel detected by said second defect detection unit in accordance with the correction method determined by said determination unit.

12. The apparatus according to claim 11, wherein the correction method includes
spatial defect correction of correcting the pixel value of the pixel in which the abnormality is detected, based on a pixel value of a neighboring pixel of the pixel in which the abnormality of the pixel value is detected by said second defect detection unit, and
temporal defect correction of correcting the pixel value of the pixel in which the abnormality is detected, based on pixel values of pixels which are identical to the pixel in which the abnormality of the pixel value is detected by said second defect detection unit and obtained from frames located temporally before and after a frame including the pixel in which the abnormality is detected.

13. The apparatus according to claim 12, wherein said determination unit determines one of the spatial defect correction and the temporal defect correction as the correction method, based on a value of a moving image frame rate included in the information indicating the imaging condition acquired by said acquisition unit.

14. The apparatus according to claim 12, wherein said determination unit determines one of the spatial defect correction and the temporal defect correction as the correction method, based on information of a body part of the object included in the information indicating the imaging condition acquired by said acquisition unit.

15. The apparatus according to claim 12, wherein said second defect correction unit compares random noise in the X-ray image, included in the information indicating the imaging condition, with an X-ray dose, and executes the correction method determined by said determination unit when a ratio of the X-ray dose to the random noise is not more than a threshold.

16. The apparatus according to claim 12, further comprising a calculation unit configured to calculate weighting information for the spatial defect correction and weighting information for the temporal defect correction, and
a weighting control unit configured to control a setting of the weighting information calculated by said calculation unit based on information acquired at the time of imaging,
wherein said decision unit determines the correction method as a combination of the spatial defect correction and the temporal defect correction based on the weighting information for the spatial defect correction and the weighting information for the temporal defect correction, settings of which are controlled by said weighting control unit.

17. The apparatus according to claim 16, further comprising a first deviation amount calculation unit configured to calculate a deviation amount of the spatial defect correction by comparing a pixel value of a pixel corrected by the spatial defect correction with a pixel value of a neighboring pixel of the corrected pixel,
a second deviation amount calculation unit configured to calculate a deviation amount of the temporal defect correction by comparing the pixel value of the pixel corrected by said temporal defect correction with pixel values of pixels which are identical to the corrected pixel and obtained from frames located temporally before and after a frame including the corrected pixel, and
an error decision unit configured to decide whether the deviation amount of the spatial defect correction and the deviation amount of the temporal defect correction fall within a predetermined error range.

18. The apparatus according to claim 17, wherein, when said error decision unit decides that the deviation amount of the spatial defect correction exceeds the error range, said weighting control unit resets the weighting information for the spatial defect correction.

19. The apparatus according to claim 17, wherein when said error decision unit decides that the deviation amount of the temporal defect correction exceeds the error range, said weighting control unit resets the weighting information for the temporal defect correction.

20. A control method for a radiographic apparatus including an X-ray irradiation unit configured to irradiate X-rays and an X-ray detection unit configured to detect an X-ray image of an object irradiated by the X-ray irradiation unit, the method comprising:
a first defect detection step of detecting, as a position-dependent defect, a pixel, of a plurality of X-ray images detected by the X-ray detection unit, whose pixel value is always abnormal, and acquiring position information of the defect in the X-ray image;
a first defect correction step of correcting the pixel value of the pixel in which an abnormality is detected, based on the position information and a pixel value of a neighboring pixel of the pixel in which the abnormality of the pixel value is detected;
an acquisition step of acquiring information indicating an imaging condition for the object when the X-ray detection unit detects the X-ray image;
a decision step of deciding, based on the information indicating the imaging condition acquired in said acquisition step, whether to further correct the X-ray image corrected in said first defect correction step;
a second defect detection step of, when it is decided in said decision step to further correct the X-ray image, detecting as a defect a pixel, of the plurality of X-ray images detected by the X-ray detection unit, which temporarily becomes abnormal dependent on a lapse of time;
a determination step of determining a correction method for correcting the pixel value of the pixel in which the abnormality is detected in said second defect detection step, based on the information indicating the imaging condition; and
a second defect correction step of correcting the pixel value of the pixel detected in said second defect detection step in accordance with the correction method determined in said determination step.

21. An image processing apparatus comprising:
a correction unit configured to execute first correction processing of correcting a pixel value of an abnormal pixel in an image based on a pixel value of a pixel located near the abnormal pixel, and second correction processing of correcting the pixel value of the abnormal pixel based on pixel values of pixels, in frame images temporarily located before and after the image, which correspond to the abnormal pixel; and
a control unit configured to control weighting for the first correction processing and the second correction processing.

22. The apparatus according to claim 21, wherein said control unit controls weighting for the first correction processing and the second correction processing based on the image.

23. The apparatus according to claim 22, wherein said control unit assigns a smaller weight to the second correction processing when movement of an object in the image as a moving image is large than when the movement is small.

24. The apparatus according to claim 21, wherein said control unit controls weighting for the first correction processing and the second correction processing based on an imaging condition for the image.

25. The apparatus according to claim 24, wherein said control unit performs control to assign a smaller weight to the first correction processing for an image obtained by performing pixel binning processing for a signal obtained from said detector than to the first correction processing for an image obtained without performing the pixel binning processing.

26. The apparatus according to claim 21, wherein weighting for the first correction processing and weighting for the second correction processing are controlled based on an image processing condition for the image.

27. The apparatus according to claim 26, wherein said control unit performs control to assign a smaller weight to the first correction processing when a frequency band to be enhanced in the image is low than when the frequency band is high.

28. The apparatus according to claim 21, wherein said control unit controls a value indicating the weighting based on at least one of a pixel pitch of a detector used for capturing the image, execution/non-execution of pixel binning processing, whether the image is a still image, a frame rate of the image as a moving image, a moving amount of an object in the image as a moving image, an imaging region of an object in the image, and a frequency band to be enhanced in the image.

29. The apparatus according to claim 21, wherein said control unit further performs control not to perform at least one of the first correction processing and the second correction processing by assigning a weight of 0 to at least one of the first correction processing and the second correction processing.

30. The apparatus according to claim 21, wherein said control unit controls at least one of the number of pixels used for one of the first correction processing and the second correction processing, a weight assigned to the pixel, and the number of frame images used for the second correction processing.

31. A control method for an image processing apparatus, the method comprising:
a correction step of executing first correction processing of correcting a pixel value of an abnormal pixel in an image based on a pixel value of a pixel located near the abnormal pixel, and second correction processing of correcting the pixel value of the abnormal pixel based on pixel values of pixels, in frame images temporarily located before and after the image, which correspond to the abnormal pixel; and
a control step of controlling weighting for the first correction processing and the second correction processing.

32. An image processing apparatus comprising:
a storage unit configured to store in advance position information of a defective pixel of an image captured by a detector before the image is captured;
a determination unit configured to determine whether to correct a temporarily abnormal pixel which is not included in the stored position information; and
a correction unit configured to correct the temporarily abnormal pixel when said determination unit determines to correct the temporarily abnormal pixel.

33. The apparatus according to claim 32, wherein said determination unit determines, based on the image, whether to correct a temporarily abnormal pixel which is not included in the stored position information.

34. The apparatus according to claim 33, wherein said determination unit determines, based on a dose of radiation applied to the detector, whether to correct the temporarily abnormal pixel.

35. The apparatus according to claim 32, wherein said determination unit determines, based on the image, whether to correct a temporarily abnormal pixel which is not included in the stored position information.

36. The apparatus according to claim 35, wherein said determination unit determines, based on a pixel value of a pixel located around the temporarily abnormal pixel, whether to correct an abnormal pixel.

37. The apparatus according to claim 32, wherein said determination unit determines whether to correct a pixel in which X-ray shot noise has occurred as a temporary pixel, by determining whether a pixel value of the pixel in which the X-ray shot noise has occurred is sufficiently smaller than a value of random noise or X-ray quantum noise superimposed on a pixel around the pixel, and
said correction unit does not correct the pixel in which the X-ray shot noise has occurred, when said determination unit determines that the pixel value is sufficiently smaller.

38. The apparatus according to claim 32, further comprising a detection unit configured to detect the temporarily defective pixel based on the image,
wherein said determination unit determines, based on the number of the temporarily defective pixels, whether to correct the temporarily abnormal pixel.

39. The apparatus according to claim 32, further comprising:
an acquisition unit configured to sequentially acquire the plurality of images obtained by moving image capturing by said detector,
said correction unit performing no correction of the temporarily abnormal pixel when said determination unit does not determine that the temporarily abnormal pixel is corrected;
an image processing unit configured to perform predetermined image processing for each image in which the temporarily abnormal pixel has not been corrected; and
a display control unit configured to cause a display unit to display each image having undergone the image processing as a moving image.

40. The apparatus according to claim 32, wherein said correction unit executes first correction processing of correcting a pixel value of a defective pixel in an image based on a pixel value of a pixel located near the defective pixel, and second correction processing of correcting the pixel value of the defective pixel based on pixel values of pixels, in frame images temporarily located before and after the image, which correspond to the defective pixel.

41. A control method for an image processing apparatus, the method comprising:
a storage step of storing in advance position information of a defective pixel of an image captured by a detector before the image is captured;
a determination step of determining whether to correct a temporarily abnormal pixel which is not included in the stored position information; and
a correction step of correcting the temporarily abnormal pixel when it is determined in the determination step that the temporarily abnormal pixel is corrected.
